(19) United States
(12) Patent Application Publication
(10) Pub. No.: US 2024/0264264 A1
(43) Pub. Date: Aug. 8, 2024

(54) ULTRA-WIDEBAND POSITIONING SYSTEM FOR WEARABLE AUGMENTED REALITY APPARATUS

(71) Applicant: Peloton Interactive, Inc., New York, NY (US)

(72) Inventors: AbdurRahman Bin Shahzad Bhatti, Clyde Hill, WA (US); Jensen Rarig Steven Turner, Everett, WA (US)

(73) Assignee: Peloton Interactive, Inc., New York, NY (US)

(21) Appl. No.: 18/431,298

(22) Filed: Feb. 2, 2024

Related U.S. Application Data
(60) Provisional application No. 63/442,875, filed on Feb. 2, 2023.

(51) Int. Cl. G01S 5/02; G01S 1/08; G01S 5/04; G01S 13/02; G01S 19/31; G06T 7/70; H04W 76/14

(52) U.S. Cl. CPC G01S 5/0284; G01S 1/08; G01S 5/04; G01S 13/0209; G01S 19/31; G06T 7/70; H04W 76/14

(57) ABSTRACT

Described herein are embodiments of methods and apparatuses for an augmented reality positioning system wherein an augmented reality device may directly (or indirectly through a separate smart device) connect with a constellation of beacons with ultra-wideband (UWB) modules to estimate a position and overall attitude for the augmented reality device and modify the perceived position of a virtual elements in space accordingly. The embodiments may include configurations for how various devices may connect and send data between one another. The embodiments may further include various constellation arrangements for beacons as well as embodiments of methods of trilateration that may be used to interpret data from various beacons.

### CROSS-REFERENCE TO RELATED APPLICATIONS

This application claims the benefit of U.S. Provisional Application No. 63/442,875, filed Feb. 2, 2023, the contents of which are incorporated herein by reference.

### BACKGROUND

Augmented reality devices superimpose computer-generated images on a user's view of reality, thus providing a mixed or augmented reality. Augmented reality apparatuses use multiple sensors and data sources in order to create a superimposed image that looks three dimensional to the user.

Determining the real-time position of an augmented reality device (as well as potentially other devices or accessories related to the augmented reality experience) may require data from multiple sensors to be compiled and synthesized to create reliable estimates for various applications.

### SUMMARY

Described herein are embodiments of methods, apparatuses, and applications for an augmented reality positioning system. Some embodiments of the augmented reality positioning system may include an augmented reality device which may be operationally connected to a UWB initiator, which may be configured to connect with UWB responders in a constellation of beacons and may send estimates for distances between beacons and the UWB initiator to a processor, which may interpret that distance data to estimate a position for the augmented reality device. In some embodiments, each beacon may have a power source and in some other embodiments, each beacon may contain a passive UWB responder without a power source.

Some embodiments of the augmented reality system may include a smart device with a UWB initiator that may be configured to connect with the UWB responders in a constellation of beacons, and may have an onboard processor configured to interpret distance data from the UWB initiator, estimate a position, and send that positional estimate to an augmented reality device via a wireless connection. Some embodiments of the smart device may include a global positioning system (GPS) unit.

Some embodiments of the augmented reality device may include an inertial measurement unit (IMU) sensor, which may output data that affects the final estimated attitude of the augmented reality device. Some embodiments of the augmented reality device may further include a camera, which may take in visual data and interpret it in a way that affects the final estimated attitude of the augmented reality device.

Some embodiments of the augmented reality positioning system may further include an accessory with a UWB module that may be configured to connect with UWB responders in a constellation of beacons and estimate its position.

In some embodiments, UWB initiators and receivers may have varying antenna radiation patterns, and the constellation of UWB beacons may be arranged in such a way to increase the chances of a UWB initiator maintaining meaningfully strong connections to multiple beacons. In some embodiments, various trilateration algorithms may be used to interpret data from UWB modules and estimate a position for a device.

### BRIEF DESCRIPTION OF THE DRAWINGS

A more detailed understanding may be had from the following description, given by way of example in conjunction with the accompanying drawings, wherein:

FIG. 1A is a block diagram of an example system depicting an augmented reality positioning system in accordance with some embodiments;

FIG. 1B is a block diagram of another example system depicting an augmented reality positioning system in accordance with some embodiments;

FIG. 2A is a block diagram of another example system depicting an augmented reality positioning system in accordance with some embodiments;

FIG. 2B is a block diagram of another example system depicting an augmented reality positioning system in accordance with some embodiments;

FIG. 2C is a block diagram of another example system depicting an augmented reality positioning system in accordance with some embodiments;

FIG. 2D is a block diagram of another example system depicting an augmented reality positioning system in accordance with some embodiments;

FIG. 3A is a diagram illustrating an example of a radiation pattern of a type of antenna in accordance with some embodiments;

FIG. 3B is a diagram illustrating an example of a radiation pattern of another type of antenna in accordance with some embodiments;

FIG. 3C is a diagram illustrating an example of a cross-section of a radiation pattern of a type of antenna in accordance with some embodiments;

FIG. 4 is a diagram that illustrates an example of how some beacons may be obstructed in accordance with some embodiments;

FIG. 5A is a diagram that illustrates an example arrangement of beacons that may be used to determine the position of an object in accordance with some embodiments;

FIG. 5B is a diagram that illustrates another example arrangement of beacons that may be used to determine the position of an object in accordance with some embodiments;

FIG. 5C is a diagram that illustrates another example arrangement of beacons that may be used to determine the position of an object in accordance with some embodiments;

FIG. 5D is a diagram that illustrates another example arrangement of beacons that may be used to determine the position of an object in accordance with some embodiments;

FIG. 5E is a diagram that illustrates another example arrangement of beacons that may be used to determine the position of an object in accordance with some embodiments;

FIG. 5F is a diagram that illustrates another example arrangement of beacons that may be used to determine the position of an object in accordance with some embodiments;

FIG. 6A is a diagram that illustrates an example of how the most likely position of an object might be determined based at least in part on the readings from at least three UWB beacons;

FIG. 6B is a diagram that illustrates another example of how the most likely position of an object might be determined based at least in part on the readings from at least three UWB beacons;

FIG. 6C is a diagram that illustrates another example of how the most likely position of an object might be determined based at least in part on the readings from at least three UWB beacons;

FIG. 6D is a diagram that illustrates another example of how the most likely position of an object might be determined based at least in part on the readings from at least three UWB beacons;

FIG. 7A is a diagram that illustrates an example application of how an augmented reality positioning system with UWB beacons may be used; and

FIG. 7B is a diagram that illustrates another example application of how an augmented reality positioning system with UWB beacons may be used.

### DETAILED DESCRIPTION

Although features, techniques, approaches, examples, cases, situations, and elements are described above in particular combinations, one of ordinary skill in the art will appreciate that each of these features, techniques, approaches, examples, cases, situations, and elements may be used alone or in any combination with the other features, techniques, approaches, examples, cases, situations, and elements.

In addition, the methods described herein may be implemented in a computer program, software, or firmware incorporated in a non-transitory computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

One of the key difficulties for augmented reality devices is determining an accurate, real-time estimate for their user's position (as well as the corresponding relative position of virtual objects superimposed onto a user's field of view) within a given space. Solutions to this problem have various benefits and shortcomings depending on the situation and objectives of the augmented reality device.

One such solution for an augmented reality device estimating its position may include ultra-wideband (UWB) modules. As used herein, the term ultra-wideband modules may include devices that employ a wide bandwidth (typically defined as greater than 20% of the center frequency or 500 MHz).

A given UWB module may be able to function as a UWB initiator and/or a UWB responder. In order for a UWB initiator to estimate its distance from a UWB responder, it may transmit billions of signal pulses across the wide spectrum frequency, which the UWB responder may receive and translate into data by listening for a familiar pulse sequence sent by the initiator. The UWB responder may then transmit signal pulses back to the UWB initiator in a sequence the UWB initiator is able to recognize and the UWB initiator may use the amount of time between sending and receiving signals to estimate the distance between the UWB initiator and UWB responder (as well as an estimate for the direction of the UWB responder relative to the UWB initiator in accordance with some embodiments). In several existing UWB systems, signal pulses are sent about one every two nanoseconds, which helps UWB systems achieve real-time accuracy.

Disclosed herein are embodiments of an augmented reality positioning system. In accordance with some embodiments, an augmented reality device may connect with a constellation of UWB beacons either directly or indirectly via a smart device. The augmented reality device may use estimates for distances to various beacons to trilaterate an estimate for its position. Various other sensors may be used to help determine a position and overall attitude for a user of the augmented reality device, including an inertial measurement unit (IMU) sensor, global positioning system (GPS) unit, and a camera. In accordance with some embodiments, the augmented reality device may also receive the position of a separate accessory that may also be able to connect with a constellation of UWB modules.

As used herein, the term attitude may include the position and/or the orientation of a user or a virtual object or system.

As used herein, the term GPS may reference any global navigation satellite system (GNSS), which may refer to data that may include an estimate of the geographic position from one or more constellations of satellites. In accordance with some embodiments, a GPS unit may be operationally linked to the global positioning system (GPS) satellite constellation. In accordance with other embodiments, a GPS unit may be GLONASS, Galileo, and/or BDS unit, receiving information from at least one or more constellations of satellites.

As used herein, the term BLE may reference Bluetooth Low Energy or any method of short-range wireless communication directly between two devices.

As used herein, the term trilaterating may reference using multiple distance estimates for estimating the a position for a given object and/or device.

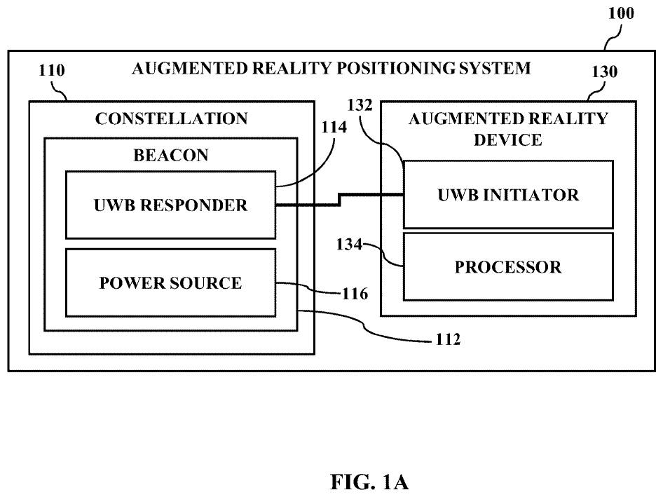

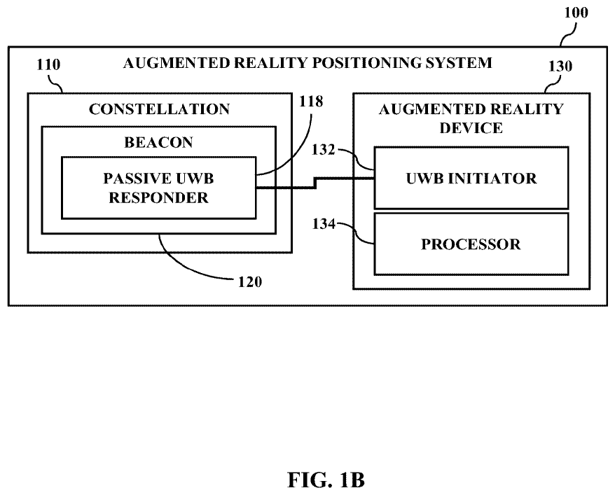

FIG. 1A is a block diagram of example augmented reality positioning system 100. In accordance with some embodiments, augmented reality positioning system 100 may include constellation 110. In accordance with some embodiments, constellation 110 may be at least partially comprised of a set of one or more beacons like beacon 112, where each beacon in constellation 110 is at a known location. In accordance with some embodiments, one or more beacons in constellation 110 are stationary. In accordance with some other embodiments, one or more beacons in constellation 110 are moving constantly or intermittently in predictable patterns.

In accordance with some embodiments, beacon 112 may contain power source 116. In accordance with some embodiments, UWB responder 114 may be included in beacon 112 and power source 116 may provide power to an active antenna in UWB responder 114, which, in accordance with some embodiments, may increase distance range of UWB responder 114. In accordance with some embodiments, power source 116 may be a battery that is rechargeable and/or replaceable. In accordance with other embodiments, power source 116 may refer to a wired connection to an external power source such as an electrical outlet.

In accordance with some embodiments, augmented reality positioning system 100 may include augmented reality device 130. In accordance with some embodiments, augmented reality device 130 may be an augmented reality headset. In accordance with other embodiments, augmented reality device 130 may be a smartphone running an augmented reality application.

In accordance with some embodiments, augmented reality device 130 may include UWB initiator 132. In accordance with various embodiments, UWB initiator 132 may constantly or intermittently broadcast signal pulses in the UWB frequency range. In accordance with some embodiments, UWB responder 114 may be configured to receive UWB signals from UWB initiator 132 and send UWB signal pulses back to UWB initiator 132.

In accordance with some embodiments, UWB initiator 132 may be able to estimate a distance between UWB responder 114 and UWB initiator 132 based at least in part on an amount of time between UWB initiator 132 sending a UWB signal to UWB responder 114 and UWB initiator receiving a UWB signal back from UWB responder 114. In accordance with some embodiments, a distance between UWB responder 114 and UWB initiator 132 may be used as a proxy for and be regarded as operationally interchangeable with a distance between beacon 112 and augmented reality device 130.

In accordance with some embodiments, UWB initiator 132 may be configured to send and receive UWB signals from all beacons in constellation 110. In accordance with some embodiments, augmented reality device 130 may include processor 134. In accordance with some embodiments, processor 134 may be configured to receive data from UWB initiator 132 that includes information on estimated distances between beacons in constellation 110 and augmented reality device 130. In accordance with some embodiments, processor 134 may synthesize estimated distances to output an estimated position for augmented reality device 130 and/or for a user of augmented reality device 130 relative to beacons in constellation 110. In accordance with some embodiments, a position estimate generated by processor 134 may be used by augmented reality device 130 to alter perceived positions of virtual objects and/or information presented to a user of augmented reality device 130.

As shown in FIG. 1B, in accordance with some embodiments, constellation 110 may include one or more beacons like beacon 120. In accordance with some embodiments, beacon 120 may contain passive UWB responder 118. In accordance with some embodiments, passive UWB responder 118 may be configured to passively receive power from an external power source that is not physically connected to beacon 120. In accordance with some embodiments, augmented reality device 130 may contain a power source that passive UWB responder 118 may derive at least some power from.

In accordance with some embodiments, passive UWB responder 118 may be configured to receive UWB signals from UWB initiator 132 and send UWB signal pulses back to UWB initiator 132. In accordance with some embodiments, UWB initiator 132 may be operationally configured to receive a response UWB signal from passive UWB responder 118 and may estimate a distance between passive UWB responder 118 and UWB initiator 132 (similar to how UWB responder 114 may interact with UWB initiator 132).

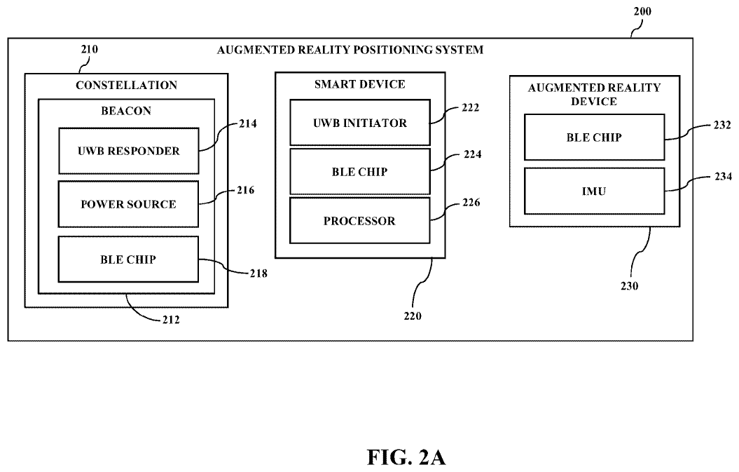

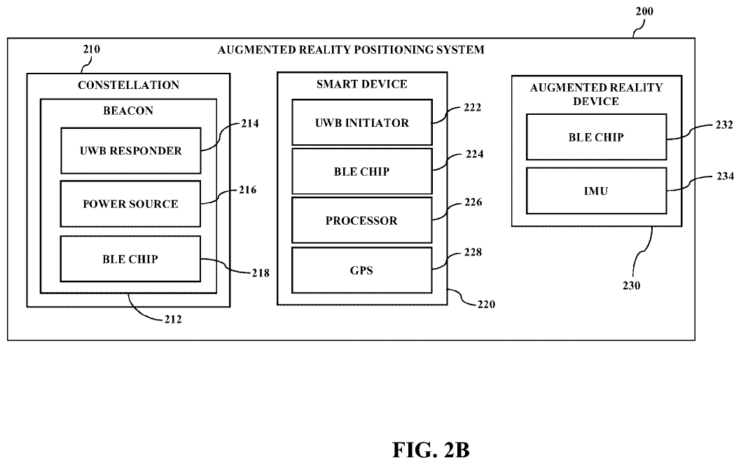

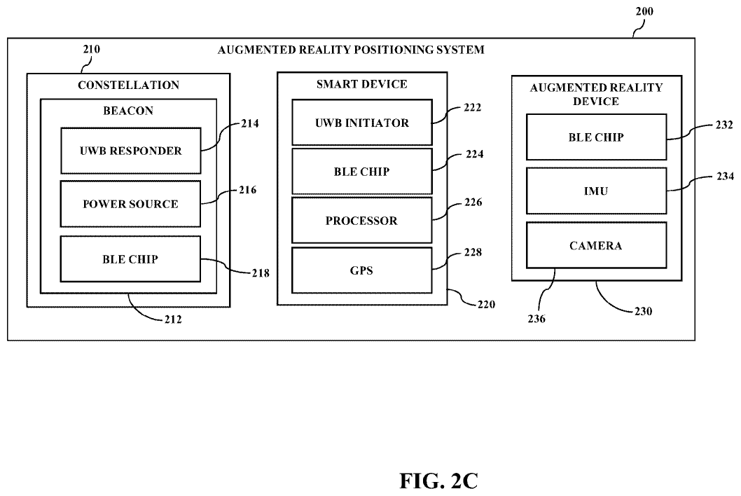

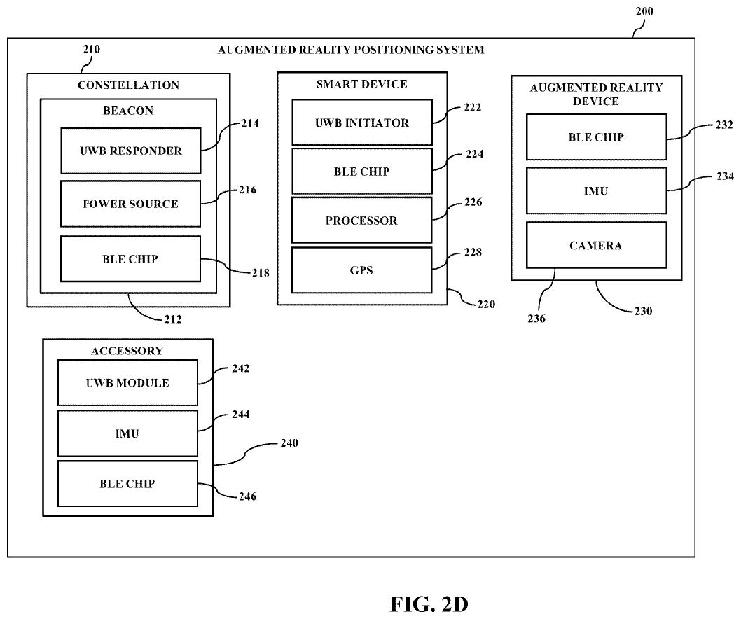

FIG. 2A is a block diagram that shows an example of augmented reality positioning system 200. In accordance with some embodiments, augmented reality positioning system 200 may include constellation 210, which may be at least partially comprised of beacons like beacon 212.

In accordance with some embodiments, beacon 212 may include UWB responder 214. In accordance with some embodiments, beacon 212 may include power source 216, which may be configured to provide power to UWB responder 214 and BLE chip 218. In accordance with some embodiments, power source 216 may be a battery that is rechargeable and/or replaceable. In accordance with other embodiments, power source 216 may refer to a wired connection to an external power source such as an electrical outlet.

In accordance with some embodiments, augmented reality positioning system 200 may include smart device 220. In accordance with some embodiments, smart device 220 may refer to a smartphone. In accordance with other embodiments, smart device 220 may refer to a smartwatch. In accordance with some other embodiments, smart device 220 may refer to a tablet or a wirelessly enabled accessory without a screen.

In accordance with some embodiments, smart device 220 may include UWB initiator 222. In accordance with some embodiments, UWB initiator 222 may be an integrated circuit and antenna embedded in smart device 220. In accordance with some embodiments, UWB initiator 222 may be configured to constantly or intermittently broadcast signal pulses in the UWB frequency range. In accordance with some embodiments, beacon 212 may include UWB responder 214 may be configured to receive UWB signals from UWB initiator 222 and send UWB signal pulses back to UWB initiator 222.

In accordance with some embodiments, UWB initiator 222 may be able to estimate a distance between UWB responder 214 and UWB initiator 222 based at least in part on an amount of time between UWB initiator 22 sending a UWB signal to UWB responder 214 and UWB initiator receiving a UWB signal back from UWB responder 214. In accordance with some embodiments, a distance between UWB responder 214 and UWB initiator 222 may be used as a proxy for and be regarded as operationally interchangeable with a distance between beacon 212 and smart device 220.

In accordance with some embodiments, beacon 212 may include BLE chip 218, which may be configured to send and receive data from BLE chip 224 in smart device 220 and/or BLE chip 232 in augmented reality device 230. In accordance with some embodiments, data transferred between BLE chip 224 and BLE chip 224 may include positions of beacons in constellation 210, unique identifiers for beacons in constellation 210, and/or whether at least one of the beacons in constellation 210 has a disconnected UWB connection, is running out of power, is experiencing issues, etc. In accordance with some embodiments, BLE chip 218 may send across a BLE-based estimate for the approximate distance between beacon 212 and smart device 220 and/or a relative position of smart device 220 to beacons in constellation 210.

In accordance with some embodiments, UWB initiator 222 may be configured to send and receive UWB signals from all beacons in constellation 210. In accordance with some embodiments, smart device 220 may include processor 226. In accordance with some embodiments, processor 226 may be configured to receive data from UWB initiator 222 that includes information on estimated distances between beacons in constellation 210. In accordance with some embodiments, processor 226 may synthesize estimated distances to output an estimated position for smart device 220 relative to beacons in constellation 210.

In accordance with some embodiments, augmented reality positioning system 230 may include augmented reality device 230. In accordance with some embodiments, augmented reality device 230 may be an augmented reality headset. In accordance with other embodiments, augmented reality device 230 may be a smartphone running an augmented reality application. In accordance with various embodiments, augmented reality device 230 may be held by or worn on a person.

In accordance with some embodiments, augmented reality device 230 may include BLE chip 232. In accordance with some embodiments, a position of smart device 220 relative to constellation 210 synthesized by processor 226 may be sent to augmented reality device 230 via a connection between BLE chip 224 and BLE 232. In accordance with some embodiments, the approximate relative position of smart device 220 and augmented reality device 230 may be known by smart device 220 and/or augmented reality device 230, and BLE chip 224 may send to BLE chip 232 an estimated position of augmented reality device 230 and/or of a user of augmented reality device 230 accordingly. In accordance with some embodiments, BLE chip 224 may send a 2D or 3D coordinate to represent position.

In accordance with some embodiments, augmented reality device 230 may include IMU sensor 234. In accordance with some embodiments, IMU sensor 234 may output data from a magnetometer, a gyroscope, and/or an accelerometer. In accordance with some embodiments, data from IMU sensor 234 may be fused with positional data received by BLE chip 232 to determine a more accurate estimated position for augmented reality device 230 as well as an attitude for a user of augmented reality device 230, which may affect the perceived position of virtual objects and information generated by augmented reality device 230. In accordance with some embodiments, whether the user is stationary may be determined based at least in part on data from IMU sensor 234.

As shown in FIG. 2B, in accordance with some embodiments, smart device 220 may further contain GPS unit 228, which may output data that may include an estimate of the geographic position and/or coordinates of smart device 220. In accordance with some embodiments, the GPS coordinates of beacons in constellation 210 may be known by smart device 220. In accordance with some embodiments, processor 226 may fuse positional data from GPS unit 228 and an estimated position relative to constellation 210 to yield a more accurate and/or more stable estimate for a geographic position of smart device 228, which, in accordance with some embodiments, may be sent to augmented reality device 230 via a BLE connection between BLE chip 224 and BLE chip 232. In accordance with some embodiments, BLE chip 224 may separately send to BLE chip 232 output from GPS unit 228 and a positional estimate derived from information from UWB initiator 222.

As shown in FIG. 2C, in accordance with some embodiments, augmented reality device 230 may be operationally coupled to camera 236. In accordance with some embodiments, visual output from camera 236 may be interpreted by a computer vision algorithm (e.g. simultaneous localization and mapping) and provide information to augmented reality device 230 that may indicate a position of a user of augmented reality device 230, where a user of augmented reality device 230 is looking, and whether a user of augmented reality device 230 is laterally moving.

In accordance with some embodiments, output data from camera 236 may be fused with data from IMU sensor 234 and positional data received from smart device 220. In accordance with some embodiments, this sensor fusion may be used by augmented reality device 230 to create a more accurate/more stable positioning estimate. In accordance with some embodiments, output from camera 236 either alone or fused with data output from other sensors may provide information to augmented reality device 230 as to whether a user of augmented reality device 230 is tilting forward or backwards, sitting or standing, moving, turning or standing still. In accordance with some embodiments, readings from beacons in constellation 210 may provide a position within an augmented area that is accurate within a ˜1-2 feet margin of error and camera 236 may be used to determine where augmented reality device 230 more precisely within that margin of error.

In accordance with some embodiments, camera 236 may be used as part of the user interface that controls augmented reality device 230. In accordance with some embodiments, a user of augmented reality device 230 may perform pre-defined gestures and movements which may be intended to trigger functionality on augmented reality device 230, and in accordance with some embodiments, visual data camera 236 outputs may be analyzed by a gesture recognition program so those gestures and movements may trigger proper functionality on augmented reality device 230 and/or affect behavior of virtual elements or information generated by augmented reality device 230.

As shown in FIG. 2D, in accordance with some embodiments, augmented reality positioning 200 may include accessory 240. In accordance with some embodiments, accessory 240 may be involved with the augmented reality experience generated by augmented reality device 230. In accordance with various embodiments, accessory 240 may be a smartwatch, a handheld item such as a bat or golf club, or an object not physically on the person of a user of augmented reality device 230, such as a ball.

In accordance with some embodiments, accessory 240 may include UWB module 242. In accordance with some embodiments, UWB module 242 may be a UWB initiator that may be configured to connect to UWB initiator 214 such that accessory 242 may have access to an estimation of its distance between accessory 242 and beacons in constellation 210. In accordance with other embodiments, UWB module 242 may be a UWB responder that may be configured to connect to UWB initiator 222 and/or at least one UWB initiator operationally or physically connected to at least one beacon in constellation 210.

In accordance with some embodiments, accessory 242 may be able to determine its position relative to beacons in constellation 210 and/or its position relative to smart device 222 and/or its position relative to augmented reality device 230. In accordance with some embodiments, accessory 240 may include IMU sensor 244, which may output data from a magnetometer, a gyroscope, and/or an accelerometer. In accordance with some embodiments, data from IMU sensor 244 may be fused with positional data determined by UWB module 242 to determine an attitude for accessory 240.

In accordance with some embodiments, an attitude for accessory 240 may be sent to smart device 220 via a connection between BLE chip 246 and BLE chip 224, and smart device 220 may send that attitude to augmented reality device 230 via a connection between BLE chip 224 and BLE chip 232. In accordance with some embodiments, an attitude for accessory 240 may be sent directly to augmented reality device 230 via a connection between BLE chip 246 and BLE chip 232.

In accordance with some embodiments, beacons in constellation 210 may be able to communicate with one another and determine their relative distances and positions without the aid of central smart device 220. In accordance with some embodiments, this may include at least one processor onboard beacon 212 configured to determine and send data about the relative position of the beacons in constellation 210 to smart device 220 or augmented reality device 230.

In accordance with some embodiments, at least one beacon in constellation 210 may include a UWB initiator, which may allow at least one beacon in constellation 210 to determine its distance to other beacons in constellation 210. In accordance with some embodiments, a beacon in constellation 210 with a UWB initiator may send the coordinates of at least some of the beacons in constellation 210 to smart device 220 and/or augmented reality device 230 via BLE chip 218.

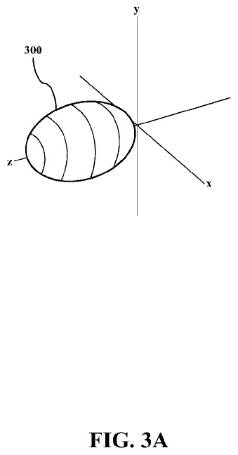

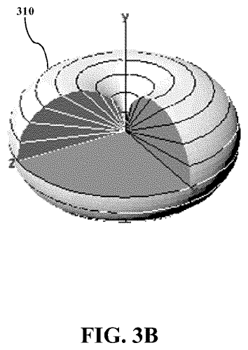

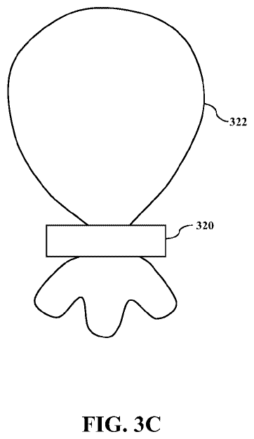

FIG. 3A shows an example of what the antenna radiation pattern (the collection of points that receive the same signal strength) from a pyramidal horn antenna might look like and FIG. 3B shows an example of what the radiation pattern from a short dipole antenna might look like. As depicted in FIG. 3A, horn antenna radiation pattern 300 is highly directional along the z-axis, which means that the signal from that antenna may be strongest if an omnidirectional receiver that is a fixed distance away from the antenna at the origin is placed on the positive portion of the z-axis.

As depicted in FIG. 3B, radiation pattern 310 is toroidal, which means that if an omnidirectional receiver is a fixed distance away from the antenna at the origin, the signal strength received will be approximately the same at any point on the xz-plane.

Maintaining a sufficiently strong signal strength connection between beacon 212 and smart device 220 may be important to the accuracy of an estimation of a distance between beacon 212 and smart device 220. In accordance with some embodiments, a weak signal connection between smart device 220 and beacon 212 may result in data lagging or being reported less frequently. Thus, in accordance with some embodiments, antenna radiation patterns of UWB responder 214 and UWB initiator 222 may be taken into account to increase the probability of sufficiently strong signal connections being maintained.

FIG. 3C depicts a cross-sectional view of a radiation pattern 322 of antenna 320. In accordance with some embodiments, antenna 320 may be part of UWB initiator 222 in smart device 220. In accordance with some other embodiments, antenna 320 may be part of UWB initiator 132 in augmented reality device 130. In accordance with some embodiments, antenna pattern 322 may be directional, with one side of the antenna being attuned to receive a stronger signal than the other.

Antenna radiation pattern may affect which orientations of smart device 220 and/or augmented reality device 130 may yield the strongest signal connections with UWB responder beacons. Additionally, signals may be blocked or weakened by the presence of physical obstructions, including humans.

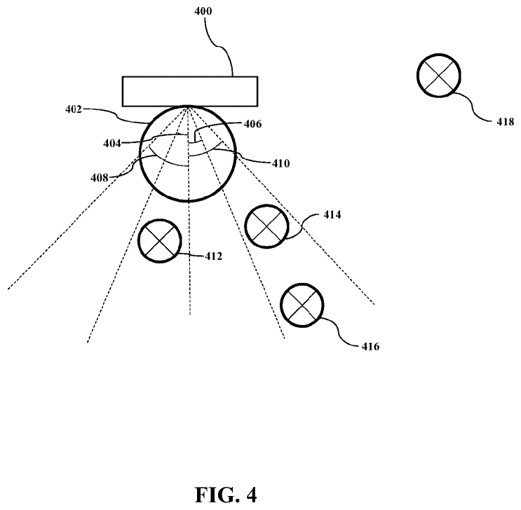

FIG. 4 is a diagram that shows an example of how UWB initiator 400 might be obstructed from maintaining connection with various UWB responders based on orientation and relative location. In accordance with some embodiments, UWB initiator 400 may be embedded in a smartphone, which may be in the pocket of or be held by user 402.

As depicted in FIG. 4, in accordance with some embodiments, user 402 may obstruct the ability of UWB initiator 400 to maintain a meaningfully strong signal connection with a UWB responder that is within certain angle intercepts. As shown in FIG. 4, in accordance with some embodiments, UWB responders 412 and 414 may be the same distance away from UWB initiator 400 and UWB responder 412 may be within angle intercepts 404 and 406. In accordance with some embodiments, UWB initiator 400 may be obstructed from making meaningfully strong signal connection to UWB responder 412 but could maintain a strong signal connection with UWB responder 414, because UWB responder 414 is not within angle intercepts 404 and 406.

In accordance with some embodiments, UWB responder 416 may be farther away from UWB initiator 400 than UWB responders 412 and 414. As shown in FIG. 4, UWB responder 416 may not be within angle intercepts 404 and 406, but it may be within the larger angle intercepts 408 and 410. And, in accordance with some embodiments, UWB initiator 400 may be obstructed from maintaining a strong signal connection with UWB responder 416 because it is within angle intercepts 408 and 410. In accordance with some embodiments, UWB responder 418, which may be the same distance from UWB initiator 400 as UWB responder 416, may not be within angular intercepts 408 and 410 and may be able to maintain a meaningfully strong signal connection with UWB initiator 400.

FIG. 4 is intended to illustrate that in accordance with some embodiments, the angular intercepts that define obstruction may increase as distance between the initiator and beacons increases. In accordance with some embodiments, the magnitude of the angular intercepts may exponentially increase as the distance between a UWB initiator and a UWB responder linearly increases.

Additionally, in accordance with some embodiments, angle 404 and angle 406 may not be identical based on the antenna radiation pattern of UWB initiator 400 or the position of UWB initiator 400 relative to the body of user 402. In accordance with some embodiments, angle 408 and angle 410 may not be identical for the same reason.

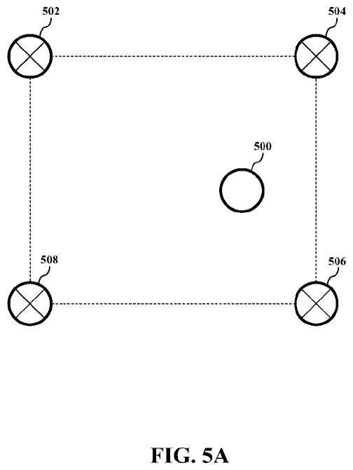

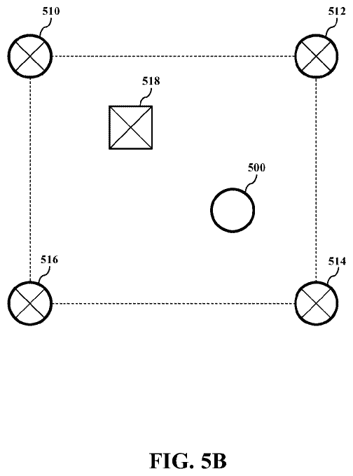

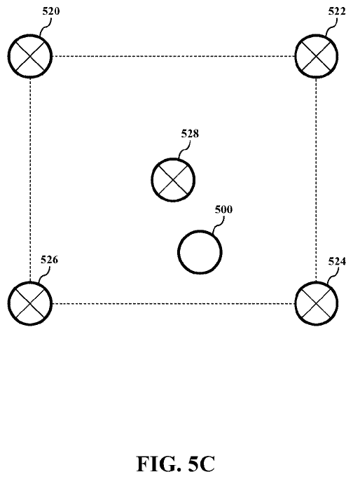

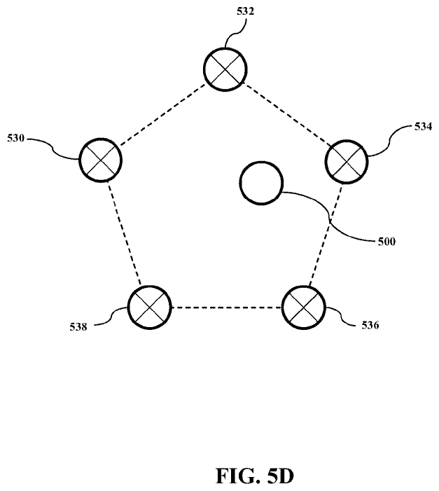

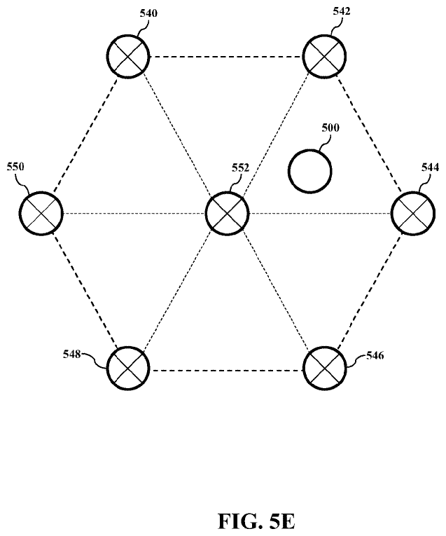

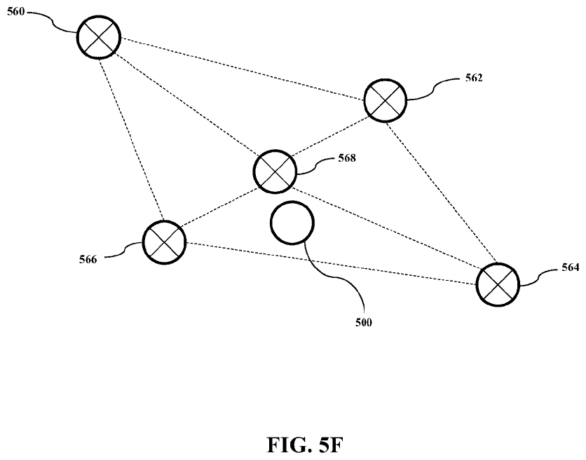

FIGS. 5A, 5B, 5C, 5D, 5E, and 5F all depict examples of some embodiments of constellation 110 and/or constellation 210. In accordance with some embodiments, constellations of UWB beacons in FIGS. 5A, 5B, 5C, 5D, 5E, and 5F may outline an area within which the position of object 500 (which may contain a UWB initiator) may be determined (hereinafter referred to as the augmented area). In accordance with some embodiments, all UWB beacons shown in FIGS. 5A, 5B, 5C, 5D, 5E, and 5F may have the same elevation and the augmented area may be flat.

As shown in FIG. 5A, UWB beacons 502, 504, 506, and 508 may be arranged in a rectangle. In accordance with some embodiments, object 500 may be able to receive data from at least three of these beacons while in the rectangle, which may be used to determine the position of object 500. The maximum distances between beacons in the arrangement depicted in FIG. 5A are the distance between beacons 508 and 504 and the distance between beacons 506 and 502.

In accordance with some embodiments, if a user is physically within the augmented area in FIG. 5A, then they may obstruct at least one of the beacons (as shown in FIG. 4). Thus, the maximum distance between beacons may be the limiting factor with regards to how large this augmented area can be. In accordance with some embodiments, with a single user in this augmented space, the maximum distance between adjacent beacons in the rectangle in FIG. 5A may be between 5 and 10 meters.

As shown in FIG. 5B, in accordance with some embodiments, UWB beacons 510, 512, 514, and 516 may also be arranged in a rectangle with object 500 within the augmented area. In accordance with some embodiments, object 518 may also be in the augmented area. In accordance with some embodiments, object 518 may be stationary. In accordance with other embodiments, object 518 may be capable of motion within the augmented area. In accordance with some embodiments, object 518 may represent a human with a device on their person.

In accordance with some embodiments, object 518 may include a UWB module. In accordance with some embodiments, object 518 may include a UWB initiator that is configured to connect to at least some of UWB beacons 510, 512, 514, and 516, which, in accordance with some embodiments, may allow object 518 to determine its position within the augmented area in FIG. 5B. In accordance with some embodiments, object 518 may further include a UWB responder which may be configured to connect with a UWB initiator operationally coupled to object 500 such that, in accordance with some embodiments, object 500 may be able to determine an estimate for its distance from object 518. In accordance with some embodiments, object 518 may include a BLE chip which may be configured to connect to a BLE chip operationally coupled to object 500, and, in accordance with some embodiments, this BLE connection may allow object 518 to transmit its position within the augmented area to object 500 (and/or vice versa).

In accordance with some embodiments, by virtue of having an estimate for a distance between object 500 and object 518 and having an estimate for a position of object 518 within the augmented area, object 500 may interpret object 518 as another UWB beacon in a constellation. In accordance with some embodiments, object 518 may physically obstruct the ability of object 500 to maintain a meaningfully strong UWB signal connection with at least one of UWB beacons 510, 512, 514, and 516, which is why object 518 acting as another beacon may help maintain fidelity with regards to object 500 estimating its own position within the augmented area.

In accordance with some embodiments, object 500 and object 518 may be similar and be interpreted as UWB beacons by each other so that their augmented reality experiences may co-exist in the augmented area.

As shown in FIG. 5C, in accordance with some embodiments, UWB beacons 520, 522, 524, and 526 may be arranged in a rectangle. In accordance with some embodiments, UWB beacon 528 may be placed in the approximate center of the augmented area formed by UWB beacons 520, 522, 524, and 526. In accordance with other embodiments, UWB beacon 528 may be placed at an arbitrary point within the augmented area formed by UWB beacons 520, 522, 524, and 526 that may not be close to the center. In accordance with some embodiments, UWB beacon 528 may be contained in a different physical housing than housings of UWB beacons 520, 522, 524, and 526. In accordance with some embodiments, UWB beacon 528 may be a flat disk and the other UWB beacons 520, 522, 524, and 526 may be comparably taller. In accordance with other embodiments, all UWB beacons in FIG. 5C may have identical housings.

In accordance with some embodiments, beacon 528 may be added in order to increase the maximum possible distance between adjacent beacons in the outer rectangle formed by UWB beacons 520, 522, 524, and 526 wherein object 500 may maintain a strong enough signal connection with enough UWB beacons in the constellation to accurately estimate its position within the augmented area. In accordance with some embodiments, by adding beacon 528 close to the center of the augmented space, the maximum distance between adjacent beacons in the outer rectangle may be between 12 and 20 meters.

In accordance with some embodiments, UWB initiator in object 500 may be physically on the person of a user, with obstruction intercepts totaling to approximately 90 degrees at a given distance from UWB beacons. In accordance with some embodiments, this may mean that two or more of the UWB beacons in a rectangular constellation arrangement may be obstructed, which may make it difficult to get an accurate estimation for the position of object 500 within the augmented area.

As shown in FIG. 5D, UWB beacons 530, 532, 534, 536, and 538 may be arranged in a pentagon to create a pentagonal augmented area. In accordance with some embodiments, UWB beacons 530, 532, 534, 536, and 538 may form a regular pentagon and in accordance with other embodiments, UWB beacons 530, 532, 534, 536, and 538 may form an irregular pentagon. If UWB beacons 530, 532, 534, 536, and 538 form a regular pentagon, then even if object 500 is unable to connect with 90 degrees worth of beacons, then it may still consistently be able to receive a signal from at least three beacons no matter where it is in the augmented area in FIG. 5D, in accordance with some embodiments.

As shown in FIG. 5E, in accordance with some embodiments, UWB beacons 540, 542, 544, 546, 548, and 550 may be arranged in a hexagon. In accordance with some embodiments, UWB beacon 552 may be placed in the approximate center of the hexagon formed by UWB beacons 540, 542, 544, 546, 548, and 550. In accordance with other embodiments, UWB beacon 552 may be placed at an arbitrary point within the augmented area formed by UWB beacons 540, 542, 544, 546, 548, and 550 that is not close to the center.

In accordance with some embodiments, object 500 may identify the three closest beacons to it and use those readings to determine its position within the augmented area. In accordance with some embodiments, object 500 may use BLE or GPS to determine which of the six triangular subsections of the augmented area it is located in and trilaterate its position based solely on the beacons in that subsection.

In accordance with some embodiments, a user may need to place UWB beacons in a certain geometric arrangement prior to operation. However, due to human error, even if a user is asked to place UWB beacons in a perfect rectangle with specific dimensions, a user may not be able to place the beacons at those exact positions. As shown in FIG. 5F, UWB beacons 560, 562, 564, and 566 may be placed in the form of an arbitrary quadrilateral. In accordance with some embodiments, UWB beacons 560, 562, 564, and 566 may include UWB initiators and UWB responders and may be configured to communicate with each other via BLE.

In accordance with some embodiments, the group of UWB beacons, UWB beacons 560, 562, 564, and 566, may each be configured to estimate their distances from each of the other beacons in that group. In accordance with some embodiments, UWB beacon 506 may receive all distance estimates that are not calculated onboard UWB beacon 506 via a BLE. In accordance with some embodiments, UWB beacon 506 may average different estimates for the same distances and may estimate coordinates for UWB beacons 560, 562, 564, and 566 either assigning itself at the origin of the coordinate plane or assigning another point (e.g. the centroid of UWB beacons 560, 562, 564, and 566) as the origin of the coordinate plane in accordance with various embodiments.

In accordance with other embodiments, a user may physically go to UWB beacons 560, 562, 564, and 566 with a UWB initiator device on hand which may be used to determine positions for each of the UWB beacons relative to each other.

In accordance with some embodiments, UWB beacon 568 may be placed within an augmented area created by UWB beacons 560, 562, 564, and 566 and coordinates of UWB beacon 568 within the augmented area created by UWB beacons 560, 562, 564, and 566 may either be estimated through a similar method by which coordinates for UWB beacons 560, 562, 564, and 566 are estimated.

In accordance with some embodiments, after coordinates/relative positions for UWB beacons 560, 562, 564, 566, and 568 are established, object 500 may be able to derive an estimate for its position within the augmented area through a similar method used in FIGS. 5A, 5B, 5C, 5D, and 5E.

In accordance with some embodiments, a device with a UWB initiator (e.g. augmented reality device 130 or smart device 220) may send out UWB signals to and receive UWB signals from UWB responders in UWB beacons, which may be used by the device with a UWB initiator to determine distances between UWB initiator and each UWB beacon.

In accordance with some embodiments, by getting the data from three beacons, a device with a UWB initiator may estimate its position relative to the UWB beacons by trilaterating its position. In accordance with some embodiments, the three beacons chosen for trilateration may be the three closest beacons. In accordance with some other embodiments, the three beacons chosen may be the ones that have the strongest signal connections. In accordance with some embodiments, the strength of a signal connection may be determined by the frequency of new readings received by the UWB initiator from a given UWB responder.

Trilateration algorithms cannot rely on perfect estimations of distance and optimal results may need to assume a margin of error. Operating under this assumption, there are several methods that may return a reasonably accurate position estimate depending on the position of the UWB beacons and the estimated distance between the UWB initiator and each beacon.

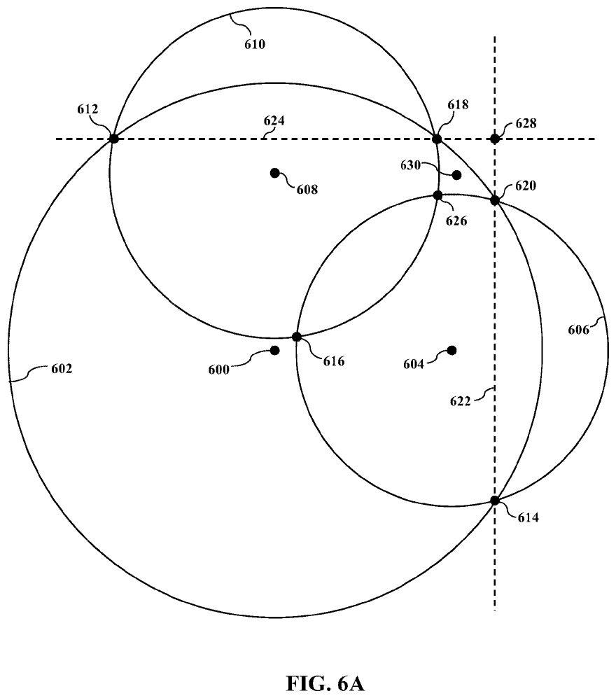

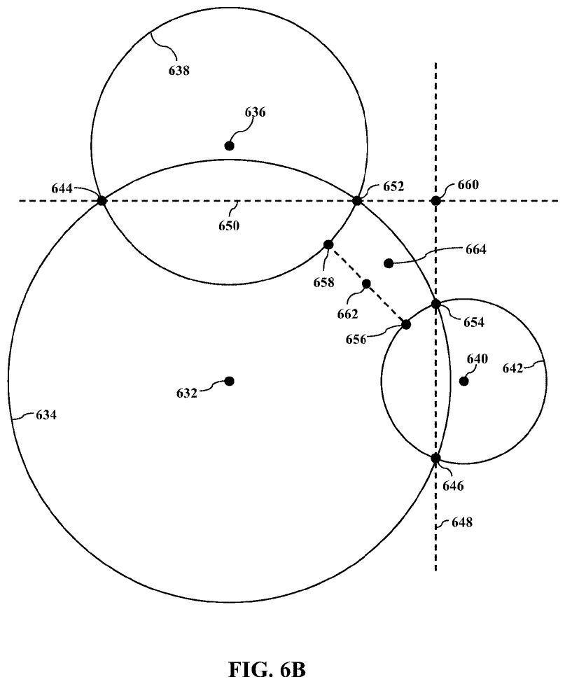

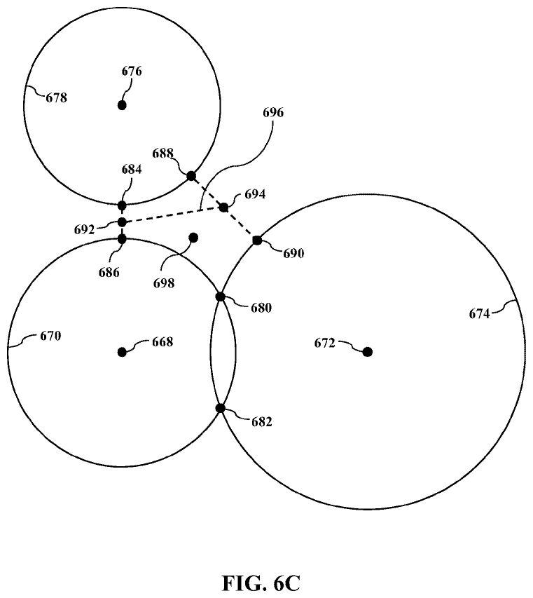

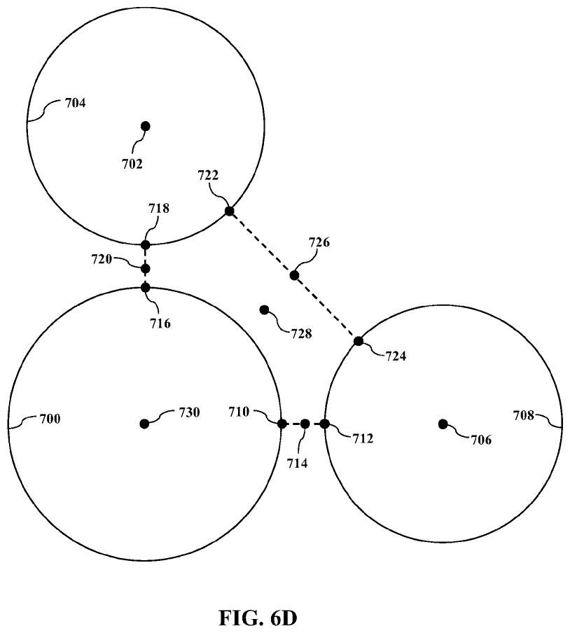

FIGS. 6A, 6B, 6C, and 6D are diagrams that illustrate examples of how trilateration algorithms may be used to estimate a position for a UWB initiator based at least in part on data from UWB beacons.

In FIG. 6A, there are three beacons at points 600, 604, and 608. The radius of circle 602, which is centered around point 600, is the distance estimated between the beacon at point 600 and the UWB initiator. Similarly, the radius of circle 606, which is centered around point 604, is the distance estimated between the beacon at point 604 and the UWB initiator. And the radius of circle 610, which is centered around point 608, is the distance estimated between the beacon at point 608 and the UWB initiator.

Points 612 and 618 are the points where circle 610 and circle 602 intersect. Line 624 is constructed to run through points 612 and 618. Points 614 and 620 are the points where circle 606 and 602 intersect. Line 614 is constructed to run through points 622 and 624. Points 616 and 626 are the points where circle 610 and circle 606 intersect.

Assuming line 624 and line 622 are not parallel (which should happen so long as the beacons are not collinear), point 628 is where line 614 and line 622 intersect. In accordance with some embodiments, point 628 may be used as the estimated position by the UWB initiator.

In accordance with some other embodiments, for each pair of intersections for each pair of intersecting circles, the closest intersection point to point 628 may be selected to determine estimated position 630. As shown in FIG. 6A, this selection process may yield the points 618, 626, and 620. In accordance with some embodiments, point 630 may be constructed as the centroid of points 618, 626, and 620. In accordance with some other embodiments, the position of point 630 within the triangle defined by points 618, 626, and 620 might be altered in accordance with the relative signal strength or fidelity from the beacons at points 600, 604, and 608. In accordance with some embodiments, point 630, may be used as the estimated position by the UWB initiator.

As shown in FIG. 6B, distances from beacons placed at points 632, 640 and 636 may not result in three circles that all intersect. As shown in FIG. 6B, the radius of circle 634, which is centered around point 632, is the distance estimated between the beacon at point 632 and the UWB initiator. Similarly, the radius of circle 638, which is centered around point 636, is the distance estimated between the beacon at point 636 and the UWB initiator. And the radius of circle 642 which is centered around point 640 is the distance estimated between the beacon at point 640 and the UWB initiator.

Points 644 and 652 are the points where circle 638 and circle 634 intersect. Line 650 is constructed to run through points 612 and 618. Points 654 and 646 are the points where circle 634 and 642 intersect. Line 648 is constructed to run through points 646 and 654. Circle 638 and circle 642 do not intersect.

Point 660 is where lines 650 and 648 intersect. In accordance with some embodiments, point 660 may be used as the estimated position by the UWB initiator. In accordance with some other embodiments, for each pair of intersections for each pair of intersecting circles, the closest intersection point to point 660 may be selected to determine estimated position 664. As shown in FIG. 6B, this selection process may yield the points 652 and 654.

In accordance with some embodiments, point 658 may be the point on circle 638 that is closest to circle 642. In accordance with some embodiments, point 656 may be the point on circle 642 that is closest to circle 638. In accordance with some embodiments, point 662 may be constructed as the midpoint between points 658 and 656. In accordance with some embodiments, point 664 may be constructed as the centroid of points 662, 654, and 652. In accordance with some other embodiments, the position of point 664 within the triangle defined by points 662, 654, and 652 might be altered in accordance with the relative signal strength or fidelity from the beacons at points 632, 640, and 636. In accordance with some embodiments, point 664, may be used as the estimated position by the UWB initiator.

As shown in FIG. 6C, distances from beacons placed at points 668, 672 and 676 may result in only one pair of circles that intersect. As shown in FIG. 6C, the radius of circle 670, which is centered around point 668, is the distance estimated between the beacon at point 668 and the UWB initiator. Similarly, the radius of circle 678, which is centered around point 676, is the distance estimated between the beacon at point 676 and the UWB initiator. And the radius of circle 674, which is centered around point 672, is the distance estimated between the beacon at point 672 and the UWB initiator.

Points 680 and 682 are the points where circle 670 and circle 674 intersect. Circle 678 does not intersect with circle 670 or circle 674. In accordance with some embodiments, point 684 may be the point on circle 678 that is closest to circle 670. In accordance with some embodiments, point 686 may be the point on circle 670 that is closest to circle 678. In accordance with some embodiments, point 692 may be constructed as the midpoint between points 686 and 684. In accordance with some embodiments, point 688 may be the point on circle 678 that is closest to circle 674. In accordance with some embodiments, point 690 may be the point on circle 674 that is closest to circle 678. In accordance with some embodiments, point 694 may be constructed as the midpoint between points 688 and 690.

In accordance with some embodiments, line 696 may be constructed to run through points 692 and 694. In accordance with some embodiments, the distance between point 680 and line 696 may be determined to be shorter than the distance between point 682 and line 696. In accordance with some embodiments, point 698 may be constructed as the centroid of points 692, 694, and 680. In accordance with some other embodiments, the position of point 698 within the triangle defined by points 692, 694, and 680 might be altered in accordance with the relative signal strength or fidelity from the beacons at points 668, 672, and 676. In accordance with some embodiments, point 698, may be used as the estimated position by the UWB initiator.

As shown in FIG. 6D, distances from beacons placed at points 730, 702, and 706 may result in three circles that do not intersect. As shown in FIG. 6D, the radius of circle 700, which is centered around point 730, is the distance estimated between the beacon at point 730 and the UWB initiator. Similarly, the radius of circle 704, which is centered around point 702, is the distance estimated between the beacon at point 702 and the UWB initiator. And the radius of circle 708, which is centered around point 706, is the distance estimated between the beacon at point 706 and the UWB initiator.

In accordance with some embodiments, point 716 may be the point on circle 700 that is closest to circle 704. In accordance with some embodiments, point 718 may be the point on circle 704 that is closest to circle 700. In accordance with some embodiments, point 720 may be constructed as the midpoint between points 716 and 718. In accordance with some embodiments, point 710 may be the point on circle 700 that is closest to circle 708. In accordance with some embodiments, point 712 may be the point on circle 708 that is closest to circle 700. In accordance with some embodiments, point 714 may be constructed as the midpoint between points 710 and 712. In accordance with some embodiments, point 722 may be the point on circle 704 that is closest to circle 708. In accordance with some embodiments, point 724 may be the point on circle 708 that is closest to circle 704. In accordance with some embodiments, point 726 may be constructed as the midpoint between points 722 and 724.

In accordance with some embodiments, point 728 may be constructed as the centroid of points 720, 714, and 726. In accordance with some other embodiments, the position of point 728 within the triangle defined by points 720, 714, and 726 might be altered in accordance with the relative signal strength or fidelity from the beacons at points 730, 702, and 706. In accordance with some embodiments, point 728, may be used as the estimated position by the UWB initiator.

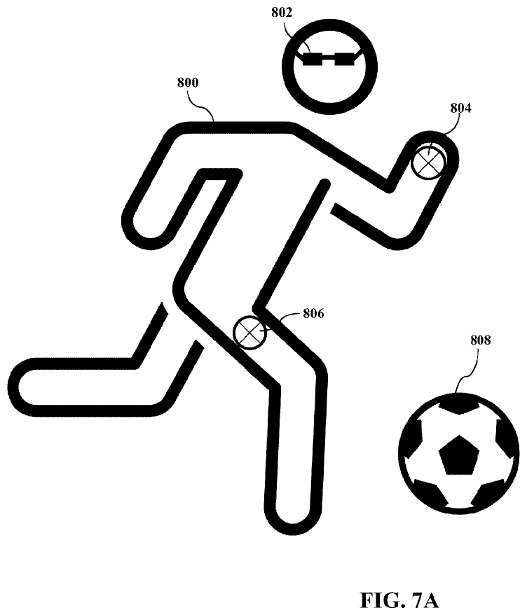

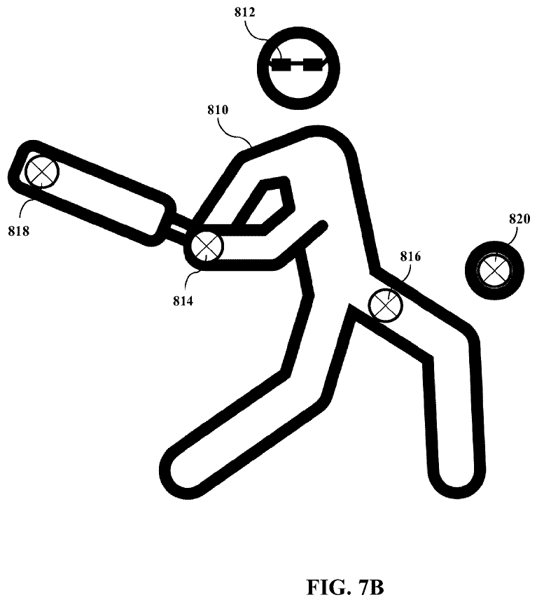

FIG. 7A depicts an example setup of an application of an augmented reality positioning system (like augmented reality positioning system 100 or augmented reality positioning system 200) that uses UWB beacons. As shown in FIG. 7A, in accordance with some embodiments, user 800 may be wearing an augmented reality headset 802, which may correspond to augmented reality device 130 or augmented reality device 230.

User 800 might also have a device with a UWB module (device 804) on their wrist. In accordance with some embodiments, device 804 may be an accessory corresponding to accessory 240. In accordance with some embodiments, device 804 may be a smartwatch that corresponds to smart device 220. In accordance with some embodiments, device 806 may contain a UWB initiator and be worn on or near the waist of user 800 and/or may be a device in a pocket of user 800. In accordance with some embodiments, device 806 may be a smartphone with an embedded UWB initiator that corresponds to smart device 220.

In accordance with some embodiments, device 806 and/or device 804 may connect to augmented reality headset 802 via BLE or via a UWB data connection. In accordance with some embodiments, augmented reality headset 802 may receive positional information from device 806 and/or device 804 to estimate the position and pose of user 800 within a flat augmented area. In accordance with some embodiments, augmented reality headset 802 may be displaying a sports-related application or simulation that shows virtual avatars meant to represent other players or objects. In accordance with some embodiments, augmented reality headset headset 802 may simulate plays for soccer, football, basketball, or any other sport, game, or activity that may be played on a flat space or field.

In accordance with some embodiments, object 808 may not be physically connected or attached to user 800. In accordance with some embodiments, object 808 may include a UWB initiator and may correspond to accessory 240. In accordance with some embodiments, augmented reality headset 802 may be able to receive the position of object 808 in an augmented area either directly or via device 806 or 804. In accordance with some embodiments, object 808 may be a ball (e.g. soccer ball, kickball, basketball, etc.).

As shown in FIG. 7B, in accordance with some embodiments, user 810 may use an augmented reality positioning system to run an application/play a game that involves handheld accessory 818, which may have an embedded UWB module. In accordance with some embodiments, handheld accessory 818 may be an object with a UWB module attached to it.

In accordance with some embodiments, object 820 may not be physically attached to user 810 and include a UWB module. In accordance with some embodiments, user 810 may be wearing device 814 on their wrist and may have smart device 816 in their pocket.

In accordance with some embodiments, device 814 and device 816 may have UWB modules that allow them to send positional information to augmented reality headset 812. In accordance with some embodiments, accessory 818 and object 820 may be configured to send positional information to augmented reality headset 812. In accordance with some embodiments, augmented reality headset 812 may alter the virtual objects and information displayed to user 810 in accordance with the calculated positions of various objects with UWB modules as well as the estimated position of user 810 within the augmented field.

It should be understood that many variations are possible based on the disclosure herein. Although features and elements are described above in particular combinations, each feature or element can be used alone without the other features and elements or in various combinations with or without other features and elements.

What is claimed:

1. An augmented reality device comprising:
an ultra-wideband module; and
a processor;
the ultra-wideband module being configured to connect to a constellation of beacons including other ultra-wideband modules;
the processor being configured to:
receive one or more estimates for a distance between the ultra-wideband module in the augmented reality device and an ultra-wideband module in at least one of the beacons; and
output a position estimate for the augmented reality device using the one or more estimates.

2. The augmented reality device of claim 1, wherein at least one beacon of the constellation of beacons including other ultra-wideband modules is passively powered.

3. A system comprising:
an augmented reality device configured to wirelessly connect to a smart device; and
the smart device, the smart device comprising:
a first ultra-wideband module;
a first transmitter; and
a first processor;
the first ultra-wideband module being configured to connect to a constellation of beacons including other ultra-wideband modules;
the first processor being configured to:
receive one or more estimates for a distance between the first ultra-wideband module and an ultra-wideband module in at least one of the beacons; and
output a position estimate using the one or more estimates; and
the first transmitter configured to send the position estimate to the augmented reality device.

4. The system of claim 3, wherein the augmented reality device includes a first inertial measurement unit (IMU), and the first processor is further configured to estimate an attitude for the augmented reality device at least in part based on synthesizing data from the first IMU and the position estimate.

5. The system of claim 4, wherein the augmented reality device includes a camera, and the first processor is further configured to estimate an attitude for the augmented reality device at least in part based on synthesizing data from the camera and the position estimate.

6. The system of claim 3, wherein the smart device includes a global positioning system (GPS) unit, and the first transmitter is further configured to:
send first data to the augmented reality device that includes second data from the GPS unit; or
send third data to the augmented reality device that is at least partially based on the second data from the GPS unit.

7. The system of claim 5, wherein the augmented reality device is configured to wirelessly connect to an accessory, the accessory comprising:
a second ultra-wideband module;
a second transmitter; and
a second processor;
the second ultra-wideband module being configured to connect to at least one of the beacons in the constellation of beacons including the other ultra-wideband modules;
the second processor being configured to:
receive one or more estimates for a distance between the second ultra-wideband module and an ultra-wideband module in at least one of the beacons; and
output a position estimate for the accessory; and
the second transmitter being configured to send the position estimate to the augmented reality device.

8. The system of claim 7, wherein the accessory includes a second IMU.

9. The system of claim 8, wherein the accessory during operation is attached to an object that is held by a person or worn by the person.

10. The system of claim 8, wherein the accessory during operation is not physically connected to a person, worn by the person, or attached to the person.

11. The system of claim 3, wherein the smart device is a smartphone.

12. The system of claim 7, wherein the accessory is a smartwatch.

13. The system of claim 3, wherein the constellation of beacons is arranged in a convex quadrilateral.

14. The system of claim 13, wherein the constellation of beacons further includes another beacon in an interior of the convex quadrilateral.

15. The system of claim 3, wherein the processor is configured to select three beacons and estimate a position coordinate;
wherein the position coordinate is approximately the centroid of a triangle, wherein each vertex of the triangle is located at a respective closest point to a pair of circles in a group of three circles, wherein each circle in the group of three circles is respectively centered at a respective location of a beacon of the three selected beacons, and wherein each circle and has a respective radius approximately equal to a corresponding estimated distance from the respective beacon.

16. The system of claim 15, wherein the three selected beacons are the three beacons in the constellation closest to the smart device.

17. The system of claim 15, wherein the three selected beacons are the beacons in the constellation that have the three strongest signal connections with the first ultra-wideband module.

18. The system of claim 3, wherein the smart device is configured to connect to a different device, the different device comprising:
a third ultra-wideband module;
a third transmitter; and
a third processor;
the third ultra-wideband module being configured to connect to at least one of the beacons in the constellation of beacons including the other ultra-wideband modules;
the third processor being configured to:
receive one or more estimates for a distance between the third ultra-wideband module and an ultra-wideband module in at least one of the beacons; and
output a position estimate for the different device; and
the third transmitter being configured to send, to the smart device, the position estimate and an estimate for the distance between the smart device and the different device;
wherein the smart device is configured to interpret information from the different device as an additional beacon in the constellation.

19. The system of claim 3, wherein the beacons in the constellation are configured to wirelessly communicate with each other, determine their relative positions, and send positional information indicating their relative positions to the smart device.

20. The system of claim 3, wherein the augmented reality device is configured to run a sports-related application.
